(19) United States
(12) Patent Application Publication
(10) Pub. No.: US 2025/0000104 A1
(43) Pub. Date: Jan. 2, 2025

(54) PROCESS FOR CONTINUOUS EXTRUSION OF MULTIPLE MATERIALS FOR ALTERNATIVE MEAT PRODUCTION

(71) Applicant: BAR ILAN UNIVERSITY, Ramat Gan (IL)

(72) Inventors: Hagay SHPAISMAN, Kedumim (IL); Ehud GREENBERG, Givat Zeev (IL)

(21) Appl. No.: 18/576,453

(22) PCT Filed: Jul. 6, 2022
(86) PCT No.: PCT/IL2022/050730

§ 371 Date: Jan. 4, 2024

Related U.S. Application Data
(60) Provisional application No. 63/203,044, filed on Jul. 6, 2021.

(51) Int. Cl. A22C 7/00; A22C 5/00; A23J 3/22; A23J 3/26; A23L 13/00; A23L 17/00; A23P 30/25

(52) U.S. Cl. CPC A22C 7/0007; A22C 5/00; A23J 3/227; A23J 3/26; A23L 13/00; A23L 17/00; A23P 30/25

(57) ABSTRACT

The technology disclosed herein concerns systems and processes for producing cut meat and cut fish products.

### TECHNOLOGICAL FIELD

The invention generally contemplates a process and a system for extrusion of food products.

### BACKGROUND OF THE INVENTION

Meat production contributes heavily to the increase in greenhouse gas emissions, deforestation, soil degradation, water stress and coastal “dead” zones. Beef-based products are also extremely inefficient to produce, as cattle consumes huge amounts of calories and proteins in order to produce relatively small amounts of calories and protein for human consumption. However, the demand for meat products increases at a ˜2.5% rate annually.

Presently available alternative approaches allow formation of ground meat products such as hamburgers and sausages. However, sales of ground meat in countries such as the US holds just 40% of a total multi-billion-dollar market, while cut meat holds 60% of the market. It is therefore clear that production of alternative cut meats is required. The reason that market leaders prefer production of alternative ground meat is clear—ground meat does not require formation of texture and a designed combination of various components. The texture becomes relevant, and thus requires attention, only where cut meat products are characterized by having areas made from muscle cells and areas made from fat cells, and where a unique desired texture is endowed, for example, by fibers in the muscle tissues.

Several methodologies have been developed to produce cut meats. Cultured meat produced by in vitro cell culture of animal cells can conceptually be designed to grow as cut meat. However, this method faces many challenges on way to being industrialized.

Another approach to producing cut meat is to inkjet print the muscle and fat cultured cells to form the desired structure. However, this approach is extremely slow and prone to a variety of problems. A similar approach is to 3D print plant-based proteins utilizing 3D printers that have a single nozzle for each material. However, this printing method is similarly too slow to meet a desired production rate. Additionally, 3D printers do not meet industrial standards for mass production as they are prone to problems such as nozzle jam, many moving parts, non-continuous process, etc.

### BACKGROUND PUBLICATIONS

WO 2019/8800867

DE 102005043381

U.S. Pat. No. 6,436,455

U.S. Pat. No. 6,199,346

DE 102019106741

EP 03005878

JP 3959122

U.S. Pat. No. 6,042,466

### GENERAL DESCRIPTION

Extruding cut meat from plant based or cultured cells using current technologies is hard to industrialize. Conceptually, it requires extracting at least two materials (equivalent to muscle and fat) through multiple differently shaped dies having different cross sections. To achieve uniform flow of different materials through differently shaped dies, two options are presently available:

(1) Using multiple separate pumps, wherein s each separate pump is dedicated for delivering an output of same material with identical cross-sections. This approach permits for each pump to be controlled separately to give an overall uniform flow; however, the increase in the number of pumps makes this approach impractical.

(2) Extruding through holes that allow adjusting for variation in cross-sections. This approach is limited by the requirement to insert a separate element and extruding into an outer template which limits production to the length of the outer template.

To overcome these and other difficulties encountered in the field, the inventors of the technology disclosed herein have developed a novel methodology for producing cut meat or cut fish products made from alternative resources (i.e., for producing plant-based or culture-based substitute meat products). The technology utilizes a continuous and a uniform extrusion process employing a customizable component. The methodology enables manufacturing cut meat and fish products that comprise a plurality of material regions mimicking a product derived from beef, cattle or fish and which may be easily varied to more closely resemble the real cut meat.

In most general terms, the technology disclosed herein utilizes a recipient housing that is configured to receive a plurality of materials, such that each material flow is governed by an independent material displacement mechanism, e.g., a pump or a piston member. The number of pumps or piston members is governed by, but may not be dependent solely on, the number of materials to be flown or extruded, such that generally only one displacement mechanism, e.g., pump, may be used per each material. This is achieved, in general, by accounting and adjusting for flow dynamics and/or utilizing layer-or feature-multiplication techniques. The latter provides a unique ability to decorate the product with numerous small elements that may be required to mimic various real meat cuts.

Thus, systems of the invention comprise an extrusion assembly comprising one or more 3D-shaped die units, configured and operable together to provide a continuous extrusion process involving continuous delivery of multiple materials to produce a product having a predefined shape and visuality. Each of the die units is configured to combine two or more materials into a final desirable shape, at a predesigned or controllable flow rate. Material distribution is achieved by accounting and adjusting for flow dynamics while considering mechanical constrains on each of the die units. In some implementations of the invention, materials are extruded in a continuous process through a mesh that may be adjusted to additionally provide predefined structural or mechanical properties (e.g., mesh size, shape, separation, etc.), to provide a cut with a set of visual attributes as well as tailored texture. Flow rates of the different component are adjusted and synchronized with a conveyor belt that removes the extruded material (the “extruded prime”) from which cut meat may be obtained.

Processes of the invention may be carried out on any machinery that fits industrial standards. While die units may be shaped and operated to allow producing various meat cuts, the continuous process ensures high reproducibility. Systems of the invention (even those utilizing a slowest setting) have demonstrated beyond state-of-the-art production rates of at least 2 Kg/min and may reach rates of as high as 30 Kg/min, as compared to 0.25 Kg/min known for systems of the art (3D single-nozzle printing), as further demonstrated hereinbelow.

It is therefore an aim of the technology disclosed herein to provide a system and a process for producing food products characterized by regions of different materials and/or textures, mimicking equivalent products derived from real meat.

In a system of the invention there are provided:

a plurality of material reservoirs comprising each same or different food component or composition, a corresponding plurality of pumps configured and operable to dispense a material from one or more of the reservoirs into corresponding feeding tubes connecting each of the reservoirs to a corresponding conduit internally present in a housing, each of said conduits being positioned at predetermined locations and distances within the housing, which position defining a relative position of a material in the final product;

the housing having an open front (exit die) from which an extruded prime may exit and a back end hermetically associated with each of the feeding tubes, each of the conduits extends within the housing interior from the feeding tubes (or pumps or material reservoirs) to the open front end of the housing.

In a first aspect of the invention, there is provided a system for producing a food product, the system comprising
a die unit comprising a housing having an inner cavity, an exit end shaped and sized to define an external contour (or shape) of the food product, and a back end and
two or more feeding tubes hermetically positioned at the back end of the housing and extending outwardly therefrom, each of the two or more feeding tubes being independently associated with one of two or more material conduits (e.g., such that each feeding tube is configured and operable to feed or flow or allow a communication of a material or a composition into a single predesigned and predefined conduit) extending inwardly along a length of the inner cavity and defining each a path of a material flow (or stream) in a direction of the exit end of the housing (along the path defined by each of the one or more material conduits), and wherein each of the two or more material conduits is optionally configured, independently of the conduit shape, cross-section profile and length, to cause materials flown through each of the conduits to flow in a substantially same flow rate.

The invention further provides a system for producing a food product, the system comprising
a die unit comprising a housing having an inner cavity, an exit end shaped and sized to define an external contour (or shape) of the food product and a back end and two or more feeding tubes hermetically positioned at the back end of the housing and extending outwardly therefrom, each of the two or more feeding tubes being independently associated with one of two or more material conduits extending within the housing and defining each a path of a material flow from the two or more feeding tubes in a direction of the exit end of the housing along the path defined by each of the two or more material conduits, wherein each of the two or more material conduits being of a different shape and/or a cross-section and comprising a material flow-disrupting element(s) positioned along the path of the material flow and configured (or adapted) to cause the material flow rate from the back end of the housing to the front end of the housing to be substantially same.

The invention further provides a system for producing a food product, the system comprising two or more feeding tubes, each being independently associated with one of two or more material conduits defining paths of materials streams, wherein one or more of the material conduits being of a different shape and/or a cross-section and comprising a material flow-disrupting element(s) positioned along the path of the material flow and configured to cause the material flow rate to be substantially identical.

Further provided is a system for extrusion of a food product, the system comprising
an extrusion assembly having at least one die unit, the die unit comprises a housing having an inner cavity and two or more feeding tubes positioned at one end of the housing, each of the two or more feeding tubes being independently associated with one of two or more material conduits contained within the housing and defining paths of material flow from the two or more feeding tubes, wherein each of the two or more of the material conduits is configured to cause the material flow in each of the material conduits to be substantially same.

The present application concerns a provision of food products formed of meat or fish alternative materials, mainly plant-based, which are formed into a ready-for-use food product by means of extrusion. While systems and processes of the invention provide the ability to manufacture a great variety of food products of varying shapes and compositions, the invention mainly concerns manufacture of cut-meat-like products. Food products produced by systems and processes of the invention are provides as extruded prime which may be cut into one to several ‘cut meat’ products following extrusion, as disclosed herein.

Thus, in some embodiments, each of the processes disclosed herein may comprise a step of slicing or cutting a cut meat portion from an extruded prime product produced.

Similarly, in some embodiments, each of the systems of the invention may be associated or provided with a conveyer belt and/or a cutting tool enabling moving of the prime product exiting the system along a production line provided with a cutting tool. In some embodiments, the system is not provided with a conveyer belt.

In some embodiments, the system is provided with a cutting tool that automatically cuts predefined sized slices from the extruded prime.

As used herein, the food product is provided as an extruded prime made of meat or fish substitutes. The extruded prime may be packaged or used as is or may be sliced into one or more cut meat products, the shape of which being determined by the shape and size of the exit die or exit front of the system and the thickness of which may be defined by the end user.

As used herein, the term “cut meat” refers to a product that mimics a piece of meat or fish that has been cut from a carcass. A cut meat manufactured according to the technology disclosed herein visually resembles a real cut meat and comprises two or more regions of materials, each region having a different profile (e.g., composition, shape, size, visual appearance, taste, aroma, etc), mimicking in color, shape and mouthfeel a different component present in the cut meat, e.g., fat, muscle, bone, fibers, protein etc. These materials can be plant-based, cultured cells, animal proteins (from cattle, insects, fish etc.) and a combination of the above. As will be demonstrated hereinbelow, a cut meat of the invention is a sliced portion obtained from an extruded prime having an outermost shape and internal features defined by elements of the herein disclosed technology. The extruded prime may be cut into one or more slices, each being a food product according to the invention. While each extruded prime may suffice to produce several cut meat products, each cut meat portion may or may not be the same, i.e., visually, or texturally, from another derived from the same extruded prime, as the patterning of the product along the extruded prime may not be consistent or may vary.

Prior to slicing the extruded prime into one or more slices of a desired thickness, the extruded prime may be further treated to adjust or modify at least one physical parameter relating thereto. Such parameters may include consistency, shape, size, hardness and visual appearance. Treatment at this stage may involve any mechanical treatment, such as pressing the extruded prime, treating the prime under vacuum, reshaping the prime, forming an external coating or shell over the prime, e.g., said shell being used for prolonging shelf life of prime of cut meat obtained therefrom, stamping or marking the prime, and others. Additional treatment protocols may include thermal treatments (heating or cooling) that can change the consistency, mouthfeel, consistency, hardness and visual appearance. Chemical treatment protocols may also be applied. Following such an optional treatment, the prime may be cut into slices of various thicknesses. The above treatment protocols may be tailored to achieve a cutting procedure utilizing lower sheer forces as well as smoother profiles.

Each of the slices may be further treated or packaged individually or together with one or more additional slices.

For producing a shaped food product having a predefined external shape and a predefined internal pattern(s) and composition, i.e., a cut meat, a system of the invention comprises a die unit or a die assembly having a housing with an internal shape and an exit front which defines the external contour or shape and size of the food product, i.e., the extruded prime. The housing has an open front end, i.e., the exit end, and a back end through which the various materials can flow in a direction of the exit end. A plurality of feeding tubes is connected to the housing back end, each being associated with a corresponding conduit that extends at least some distance within the length of the housing. In some configurations, the conduits extend from the back end of the housing to the exit end thereof.

Each of the feeding tubes present outside of the housing is configured to be associated to a material reservoir through a material displacement member or unit such as a pump. Material from the material reservoir flows in the direction of the housing through the feeding tubes and the corresponding conduits towards the front opening or exit end of the conduit (and hence towards the front end or opening of the housing). As each of the conduits may be different from the other in its length, diameter, its geometrical shape, the material from which the conduit inner surface is made of, and in its cross-section profile (namely, shape of the cross section, variation in cross sections, dimeter changes along the path, etc) and as the materials flowing through each of the plurality (two or more) of conduits are independent form each other and may be different or same, the materials flowing through the conduits may flow at different flow rates. A different rate may cause difficulties in constructing a uniform extrudate or prime, therefore affecting homogeneity and uniformity of products and further may prevent a stable continuous production process. To minimize fluctuations or differences in flow rates, at least one or each of the conduits may be structured and configured to modulate flow of a material therethrough, such that the flow rate measured at the exit point (exit end of the housing) for a material flowing in each of the conduits, independently of the conduit structure and shape, and further independently of the material composition and physical characteristics (e.g., viscosity), is substantially the same. Thus, by adjusting variations in shape and conduit cross-section, adjustments in flow may be made. The necessary adjustments can be partially predicted and achieved by utilizing simulations which permit shaping of the channels or conduits, addition of static mixers, active mixers or other flow-disrupting elements, as disclosed herein, etc.

The type and geometry of the flow-disrupting elements used in conduits of the invention may be determined by Computational Fluid Dynamics (CFD). As known in the art, CFD is a mathematical modeling of a physical phenomenon involving material flow. In a CFD software analysis, examination of material flow in accordance with its physical properties such as velocity, pressure, temperature, density and viscosity is conducted. To virtually generate an accurate solution for a given flow rate associated with the material flow, these properties may be considered simultaneously. A mathematical model may vary in accordance with the content of the system and the reliability of a CFD analysis highly depends on the whole structure. The verification of the mathematical model creates an accurate case for achieving accurate or equal flow rates in all conduits.

As known in the art, the fundamental basis of almost all CFD problems is the Navier-Stokes equations, which define many single-phase fluid flows. These equations can be simplified by removing terms describing viscous actions to yield the Euler equations, which may be further simplified to yield the full potential equations. In determining material flow through the conduits, certain physical assumptions are made, which include single-phase flow, single-composition or material that is non-reacting, and potentially compressible. On the basis of such and other assumptions, relating to the material to be streamed through a conduit, suitable flow equations are solved with CFD. These include conservation laws, continuum conservation laws, compressible Navier-Stokes equations, incompressible Navier-Stokes equations, compressible Euler equations, weakly compressible Navier-Stokes equations, Boussinesq equations, compressible Reynolds-averaged Navier-Stokes equations and compressible Favre-averaged Navier-Stokes equations, and others.

The geometry and physical bounds of a conduit is defined using computer aided design (CAD). Data can thereafter be suitably processed and the fluid volume may be extracted. The volume occupied by the fluid is divided into a discrete mesh which may be uniform or non-uniform, structured or unstructured, including a combination of structures. Simulation proceeds with analysis and visualization of the resulting solutions. These may be implemented in determining the appropriate flow-disrupting members that can be used and their position along the internal volume (or surface) of the conduit.

As used herein, the expression “flow rate is substantially same” made in reference to a material flow rate in each of the conduits, means that flow rates measured in each of the conduits are within ±10% of an average measured flow rate for a given system of the invention.

In some embodiments, the system or process of the invention does not require maintaining substantially identical flow rates and thus do not make use of flow modifiers, or flow-disrupting elements.

In some embodiments, a flow rate is maintained substantially identical or same in each of the conduits by decorating or positioning, along the inner walls of the conduits, flow-disrupting elements that modulate the rate in each of the conduits in such a way that materials flowing out of the conduits have substantially the same flow rate. In some configurations, a conduit length or path may be geometrically modified to achieve a desired flow rate.

In some embodiments, the conduits are structured or shaped to increase a flow rate therethrough.

In some embodiments, the conduits are structured or shaped to decrease a flow rate therethrough.

In some embodiments, a flow may be modulated by:
narrowing or broadening conduit dimeters along a conduit length; and/or
introducing a loop pattern, a rectangular loop, a helical loop, a straight ended path corner, a rounded end corner, a moving gap, a rotating device, a grid, a vertical pillar, a shutter, a vertical or a horizontal blind; and/or
modifying an inner conduit surface roughness or smoothness; and/or
any other means.

In some embodiments, a flow may be modulated by modifying an inner conduit surface roughness or smoothness.

In some embodiments, a flow may be modulated by providing a conduit with a moving gap, a rotating device, a grid, a vertical pillar, a shutter, or a vertical or a horizontal blind.

In some embodiments, a flow may be modulated by changing the length of the conduits, by shaping the conduits, by modifying the cross section of each of the conduits along its major run (not at its end), by introducing static mixers, active mixers or other flow-disrupting elements.

In some embodiments, a flow may be governed by pressure imposed by the pumps or pistons associated with each set comprising a reservoir, a feeding tube and a conduit, and not by any of the aforementioned geometrical or mechanical means.

Due to the separation between the conduits, materials flowing therethrough are by no means capable of mixing. At the exit end of the housing, the external contour of the extrudate is defined by the shape of the die unit present at the exit end. The shape and size of each of the material regions formed within the perimeter of the extrudate is defined by the cross-section shape and profile of each of the conduits at the output ends.

In some embodiments, the exit end of the housing is equipped with a net or a grid structure through which the material flows. The net or grid structure may be modified for endowing the extrudate with a desired texture. The structure of the net or grid may be non-uniform with varying shapes, hole sizes or contour thickness that change within sections defined by the cross-sectional shape of the conduits and/or between sections formed by the different conduits and very the visual appearance and/or texture of the product.

Each of the two or more feeding tubes is associated with a separate conduit on one end and with a feeding unit at its other end. The feeding unit, comprising a material reservoir and a dispensing mechanism, e.g., a pump, contains the material or food component or composition to be flown into and through the conduits and which make up the food product. Thus, each of the two or more feeding tubes is adapted or configured to receive a different material and to be associated with a different pump.

The material reservoirs are in communication with the feeding units acting as inlets of the housing. The reservoir(s) may be shaped as containers or as hoppers. As noted herein, the material is introduced into the system housing via the feeding tubes such that the housing exit end imparts a shape to the material. The reservoir(s) can be configured to introduce the material(s) into the housing in a continuous or non-continuous manner. Materials flow from the reservoir(s) via the help of a pump or any other means that includes one or more piston or plunger-like members. Pressure may be exerted in many different manners, including use of air pressure, hydraulic pressure, and mechanical force.

A food product produced may systems and processes of the invention has a visual appearance that mimics a real cut meat derived from e.g., beef, cattle or fish. The visual appearance may be improved by utilizing a layer-multiplying unit or device that by repeated splitting and recombination of the food components, during extrusion, generates a visual appearance, in a form of e.g., features, layers, spots or structures that mimic actual different tissue features in the food product.

A layer-multiplying unit used in accordance with some aspects ad embodiments of the invention is configured and structured to produce not only layer multiplication but also feature-multiplication; thus may be referred to as a “multiplying unit” or device. The features present and multiplied may be randomly shaped regions such as layers, dots annular structures, randomly shaped structures, etc, of one material in another. These features may be continuous or spaced apart and may be substantially randomly distributed. Nevertheless, the design and distribution of the features may be predicted or achieved by selecting a multiplying feed block and one or more multiplying members or dies. The size and shape and distribution of the layers or features may be modulated by selecting the number of times the extrudable material is passed through a multiplying die element, as further disclosed herein.

Co-extrusion through a series of multiplying die elements enables the production of products having hundreds and even thousands of features, with varying thicknesses that can be as low as microns in size.

In a system or process of the invention, two or more food material streams are flown through the respective feeding tubes into a feed block to create an initial layered combination. This layered combination, being a structured combination of the two or more food materials may subsequently be flown through one or a plurality of multiplying dies which vertically split the flow path into sub-streams, which may be equal or not, that are then reoriented one on top of the other over a specified flow length. The sub-streams may then be recombined into another structured material combination having a more detailed or an intricate structure or an internal appearance that is derived from the layering and re-layering, splitting and recombination of the two or more food materials. Repeated multiplication, vertically or horizontally, may decrease layer or feature thickness and distribute the features in a random way.

The degree of material mixing or a desired visual appearance may be controlled by selecting or structuring a feed block, by the number of materials combined, by the geometry of the exit end, and/or by post-processing protocols as disclosed herein.

As used herein, the expression “layer-multiplying” refers to a device or a unit or a capability of multiplying a layer, a feature or a structure of one or more food materials to provide a visual appearance of different material regions. Despite the use of the term “layer”, multiplication may not necessarily yield a layered structure. As shown in the figures, multiplication may yield amorphic or randomly shaped material structures.

In some embodiments, a system is equipped with one or more multiplying units or a multiplying device (wherein each device optionally comprising one or more multiplying dies). In some embodiments, the multiplying unit or device is positioned between the material reservoirs and the back end of the housing.

In some embodiments, a multiplying device is positioned at the back end of the housing, between a material reservoir and entry to a feeding tube. In other words, a layered material is formed before entry into one of the feeding tubes.

In some embodiments, a multiplying device is positioned between an extruder unit or extruder assembly and an exit die.

In some embodiments, a system of the invention comprises a co-extrusion unit, a multiplying unit and an exit die, wherein the co-extrusion unit comprises the two or more conduits, each defining a different food component stream; the multiplying unit is configured to mechanically transform the different component streams into sub-streams that may be combined to form a layered or structured stream and flow through the exit die to produce a shaped food product.

As used herein, a “structured stream”, a “structured combination” and a “structured material”, encompassing the terms a “layered stream”, a “layered stream” and a “layered material”, refer to a stream or a combination or a material comprising two or more food materials that has a cross-section showing multiple features or layers of one material in another.

The multiplying units may be structured to produce features other than layers. Multiplication may be doubling of the number of layers or features by flowing the materials through several multiplication dies, wherein each multiplication die doubles the number of features, or and may similarly be multiplication by 3, 4, 5 or more.

The multiplying units may be designed in a way that the structures or features multiplied are distorted deliberately or that the extruded contour is not identical to the contour of materials inserted. The multiplying units may be applied only to a portion of the materials entering the units thus multiplying only part of the structure. These units may also have other designs where materials entering the unit with a given cross section are compressed to a portion of the cross section thus reducing dimensions of features by the same ratio. This may be followed by stage of stacking several extruded materials in a way that resembles whole meat cuts.

Utilizing a multiplying unit (which may comprise one or more multiplying elements or dies) permits formation of food products mimicking appearance of cut meat (e.g., fat, muscle, bone, fibers, protein etc.). The thickness of each layer or feature is deliberately kept large enough so it is visible to the naked eye. The multiple features formed are non-uniform and non-homogeneous to achieve a more natural appearance.

A typical multiplying unit comprises one or more multiplying dies. This design allows to create a highly flexible process for producing a food product with few to many material layers or features, mimicking the texture and visual appurtenance of the final product.

A typical multiplying unit comprises a two-component co-extrusion system comprising, for example, single screw extruders provided with pumps, a co-extrusion feed-block, a series of multiplying die elements and an exit die. From the feed-block, the two food components enter a series of multiplication dies, each of which doubles or multiplies the number of layers or features through a process of cutting, spreading, and stacking the components. A series of n multiplying elements combines two materials as alternating layers. A non-limiting design of a multiplying unit is demonstrated in FIGS. 4 and 5.

Irrespective of the configuration of the feed-block, it is to be understood that the initial pass of a material through the multiplying element generally multiplies the number of layers or features in a stack. In such a way, the number of layers or features formed may be two or more, e.g., 2, 3, 4, 5, 6, 7, 8, 9 or 10 or more.

Additionally, it should be understood that each of the multiplying units may comprise a plurality of multiplying die elements through which the material passes and the features are multiplied. The number of die elements in each unit is a matter of design and has no bearing on the invention disclosed herein. In some configurations, a certain unit may comprise a single multiplying element while in others it may comprise 2, 3, 4, 5, or more such elements.

Thus, a system of the invention may comprise one or more, or all, of:
two or more or a plurality of food components, food materials;
one or more extruders, each extruder being independently capable of receiving a food material and independently extrude said material, e.g., at a temperature and under a pressure suitable for the material;
one or more pumps for each of the extruded materials, wherein the pump may be any of a variety of displacing mechanism, pistons, etc known in the art, capable of applying pressure to said extruded material;
a feed block for receiving a pressurized material, wherein the feed block is associated or connected to a multiplying die member (or an assembly of such members, wherein each independently is configured and operable to split or divide said material into a plurality of layers or segments (e.g., depending on the initial form of the material);
an exit die for forming a structure food product having a profile showing two or more regions of two or more food components.

The invention further provides a system comprising
one or more extruders, each extruder being independently capable of receiving a food material and independently extrude said material;
one or more pumps for each of the extruded materials, wherein the pump may be any of a variety of displacing mechanism, pistons, etc known in the art, capable of applying pressure to said extruded material;
a feed block for receiving a pressurized material, wherein the feed block is associated or connected to one or more multiplying die members (or an assembly of such members), wherein each independently is configured and operable to split or divide said material into a plurality of layers or segments (e.g., depending on the initial form of the material);
an exit die for forming a structure food product having a profile showing two or more regions of two or more food components.

The invention further provides a system for extrusion of a food product, the system comprising a multiplying unit comprising a co-extrusion system (i.e., for extruding two or more materials simultaneously) comprising an extruder provided with one or more pumps, a co-extrusion feed-block provided between the extruder and a plurality of multiplying die elements arranged in series, and an exit die having an inner shape defining a shape of the food product.

In some embodiments, the extruder is a single screw extruder.

The invention further provides a system for extrusion a food product, the system comprising an extrusion assembly, a multiplying unit and an exit die, wherein the multiplying unit is positioned between the extrusion assembly and the exit die in a material path configured to transform two or more extruded materials into a structured combination of material and flow said structured combination into the exit die having a structure and size defining an external contour of the food product, wherein the extrusion assembly comprising one or more material conduits, each being associated with a corresponding feeding tube and configured to receive a material from a material reservoir.

In some embodiments, the system comprises a die unit comprising a housing having an inner cavity and an exit die, the housing having a back end and two or more feeding tubes hermetically positioned at the back end of the housing and extending outwardly therefrom, each of the two or more feeding tubes being independently associated with one of two or more pumps and with one of two or more material conduits extending inwardly and defining each a path of a material flow from the two or more feeding tubes through the multiplying unit in a direction of the exit die.

In some embodiments, the system comprising
the one or more material conduits, each defining a stream of a different food component,
an extrusion feed block configured to divide one or more of said streams into a plurality of sub-streams and to combine the sub-streams into a first stream of a food composition comprising two or more layers or features of two or more different food components,
a multiplying element configured to mechanically manipulate the first stream and rearrange the layers or features therein to provide a further stream of the food composition, wherein the number of layers or features in the further stream of the two or more different food components is greater than the number of layers or features in the first stream, and
optionally one or more further multiplying elements configured to mechanically manipulate the further stream and rearrange the layers or features therein.

Also provided is a system for producing a food product, the system comprising
a plurality of conduits each defining a stream of a different food component,
a co-extrusion feed block configured to divide one or more of said streams into a plurality of sub-streams and to combine the sub-streams into a first stream of a food composition comprising two or more layers or features of two or more different food components,
a multiplying element configured to mechanically manipulate the first stream and rearrange the layers or features therein to provide a further stream of the food composition, wherein the number of layers or features in the further stream of the two or more different food components is greater than the number of layers or features in the first stream, and
optionally one or more further multiplying elements configured to mechanically manipulate the further stream and rearrange the layers or features therein.

In some embodiments, the two or more layers or features are arranged in any orientation to each other.

In some embodiments, the two or more layers or feature have different shapes and sizes.

In some embodiments, the multiplying element and each of the one or more further multiplying elements are different. They may be different in their design and in the number of features or layers they can produce.

In some embodiments, the system comprises a co-extrusion assembly configured to simultaneously extrude two or more different food components.

In some embodiments, the system comprises a co-extrusion assembly, a multiplying unit and an exit die, wherein the multiplying unit is positioned between the co-extrusion assembly and the exit die in a path of two or more different material streams, each stream being of a different extruded material, said multiplying unit is configured to transform said different extruded materials into multiple sub-streams and rearrange said sub-streams to provide a stream of a structured material and flow said stream of a structured material through the exit die having a housing with an internal cavity defining an external contour of the food product, wherein the co-extrusion assembly comprising one or more material conduits, each being associated with a corresponding material reservoir.

In some embodiments, the system comprises a die unit comprising a housing having an exit end and a back end and two or more feeding tubes hermetically positioned at the back end of the housing and extending outwardly therefrom, each of the two or more feeding tubes being independently associated with one of two or more material conduits extending inwardly and defining each a path of a material flow from the two or more feeding tubes through the multiplying unit and in a direction of the exit end.

In some embodiments, the system is for producing a cut meat or cut fish product.

As disclosed herein, in some configurations of devices and processes of the invention, the final product stream exiting the system is passed through a mesh, a net, a grid or a screen that can be adjusted (mesh size, shape, separation, etc.) to endow the final product with a set of visual attributes as well as tailored texture. The mesh may be a physical barrier which physically patterns the material passing through it through formation of dissection lines or a functional mesh constructed of a plurality of thin hallow wires having a predefined porosity and configured to release a material contained within the hallow wires upon coming into contact with the passing product. The material contained within the hollow wires may be a further food component, a coloring agent, a flavoring agent or any other material to be embedded in the product. In some cases, the material used is selected to mimic blood or blood vessels in the final product. Release of the material from the mesh may be by capillary action, by positive pressure or may be enabled by the passing of the material on the surface of the pores present on the hollow wires.

Also provided is a process for a continuous or batch production of a food product composed of two or more material regions, the process comprising:
flowing each of two or more materials through separate material conduits having different shapes and/or cross-sections and contained within a housing having a back end and a front exit end, wherein the distance between the back end and the front end defining an inner shape of the housing, such that the two or more materials flow out of the separate material conduits in a direction of the front exit end of the housing at substantially same flow rates.

In some embodiments, the process is carried out on a system of the invention.

In some embodiments, at least one food component is flown via one or more feeding tubes provided at the back end of the housing into the conduits housed within the housing, wherein each of the two or more feeding tubes are independently associated with a different conduit contained and defining paths of materials flown in a direction away from the feeding tubes, wherein materials flown through each of the conduits is at substantially identical rates.

Also provided is a process for a continuous production of a food product composed of two or more material regions, the process comprising:
providing a first stream of a food composition comprising two layers or two features of two different food components,
passing the first stream through a multiplying element configured to mechanically manipulate the first stream and rearrange the layers or features therein to provide a further stream of the food composition, wherein the number of layers or features in the further stream of the two different food components is greater than the number of layers or features in the first stream; optionally passing the further stream through one or more further multiplying elements (for repeating said multiplication one or more times); to thereby obtain the food product having two or more material regions.

In some embodiments, the process comprises:
providing a plurality (two or more) of streams of same or different food components,
dividing each of the plurality of streams into a plurality of sub-streams, and
combining the sub-streams into the first stream of the food composition comprising two layers or features of two different food components.

The invention further provides a process for a continuous production of a food product composed of two or more material regions, the process comprising:
providing a plurality (two or more) of streams of same or different food components,
dividing each of the plurality of streams into a plurality of sub-streams,
combining the sub-streams into a first stream of a food composition comprising two layers or features of two different food components,
passing the first stream through a multiplying element configured to mechanically manipulate the first stream and rearrange the layers or features therein to provide a further stream of the food composition, wherein the number of layers or features in the further stream of the two different food components is greater than the number of layers or features in the first stream, and
optionally passing the further stream through one or more further multiplying elements (for repeating said layer-multiplication one or more times);

to thereby obtain the food product having two or more material regions.

In additional aspects, further contemplated is a process for a continuous production of a food product composed of two or more material regions, the process comprising providing a first stream of a food composition comprising two layers or features of two different food components, passing the first stream through a multiplying element configured to mechanically manipulate the first stream and rearrange the layers or features therein to provide a further stream of the food composition, wherein the number of layers or features in the further stream of the two different food components is greater than the number of layers or features in the first stream; optionally passing the further stream through one or more further multiplying elements (for repeating said layer-multiplication one or more times) to obtain a final stream; and flowing the final stream through a material conduit of an extrusion device having a plurality of material conduits of different shapes and/or cross-sections, such that the final stream and one or more additional material streams flow out of the plurality of material conduits at a substantially same flow rate; to thereby obtain the food product having two or more material regions.

In some embodiments, the process comprising:
providing a plurality (two or more) of streams of same or different food components,
dividing each of the plurality of streams into a plurality of sub-streams,
combining the sub-streams into a first stream of a food composition comprising two layers or features of two different food components,
passing the first stream through a multiplying element configured to mechanically manipulate the first stream and rearrange the layers or features therein to provide a further stream of the food composition, wherein the number of layers or features in the further stream of the two different food components is greater than the number of layers or features in the first stream, and
optionally passing the further stream through one or more further multiplying elements (for repeating said layer-multiplication one or more times).

In some embodiments, the process may further comprise a step of providing a co-extrusion die unit before the multiplying unit in such a way that the input for the multiplying unit is not composed of a homogenous structure. This may include, but not limited to, arbitrary shaped combinations of materials, and/or layered structures that are not homogeneous in thickness or have shapes within the layers, and/or layered structures that are not horizontal in respect to the main axis of the layer-multiplying element, and/or layered structures with arbitrary shaped combinations of materials in-between layers, and/or a combination of the above.

In additional embodiments, the process comprises:
optionally shaping the exit die after the layer-multiplying unit to allow expansion or reduction of cross section to adjust for the cross section of the external shape of the cut meat product. The expansion or reduction could optionally be formed non-homogeneously to provide twisting, bending and/or stretching of the extruded shape for a more realistic appearance.
optionally adding to the exit die after the layer-multiplying unit static mixers, active mixers or other flow-disrupting elements to provide twisting, bending and/or stretching of the extruded shape for a more realistic appearance.

As noted above, any of the processes of the invention may further comprise a step of treating the extruded prime prior to slicing to adjust or modify at least one physical parameter relating thereto. Such parameters may include consistency, shape, size, hardness and visual appearance. The treatment step(s) may comprise any mechanical treatment, such as pressing the extruded prime, treating the prime under vacuum, reshaping the prime, forming an external coating or shell over the prime, e.g., said shell being used for prolonging shelf life of prime of cut meat obtained therefrom, stamping or marking the prime, and others.

Following such steps, the prime may be cut into slices of various thicknesses. Each of the slices may be further treated or packaged individually or together with one or more additional slices. The slices may be obtained by mechanical slicing units or by cutting by hand.

The materials used for making up the cut meat or cut fish substitutes may be selected amongst plant-based materials or may be any synthetic or semi-synthetic materials that endow the end product with a desired visuality, taste and smell. Such materials may be present as mixtures or as separate material regions within the cut meat or cut fish. In other words, the material reservoirs from which materials are communicated into the conduits may comprise each a single material component or a mixture of components.

Materials or mixtures of materials may comprise or consist any one of more of:

1. Amino acids: Amino acids used in cut meat or cut fish products of the invention may be provided in either the L-or D-form or in a racemic form. Additionally or alternatively, the amino acids may be selected from essential, non-essential and conditional amino acids, as known in the art. Typically, the amino acid(s) utilized in products of the invention is one or more or a combination of amino acids selected from natural, synthetic or semi-synthetic sources. The amino acid may be alanine, arginine, asparagine, aspartate, cystine, cysteine, glutamine, glutamate, glycine, histidine, isoleucine, leucine, lysine, methionine, phenylalanine, proline, serine, threonine, tryptophan, tyrosine and valine. In some embodiments, the amino acid is cysteine, cystine, histidine, isoleucine, leucine, lysine, methionine, phenylalanine, threonine, tryptophan, and valine.

In some embodiments, the amino acid is selected amongst essential amino acids. Such may be any one or more of histidine, isoleucine, leucine, lysine, methionine, phenylalanine, threonine, tryptophan, and/or valine.

In some embodiments, the cut meat or cut fish product comprises two or more amino acids or a blend or a combination of amino acids. In some embodiments, the amino acids are provided as short peptides such as di, tri, tetra or pentapeptides.

2. Carbohydrate: Carbohydrates may be selected amongst natural materials, synthetic/biosynthetic materials or semisynthetic/semibiosynthetic material. The carbohydrate may be a monosaccharide, a disaccharide, an oligosaccharide, or a polysaccharide. In some embodiments, the carbohydrate is selected from cyclic oligosaccharides, maltodextrins, beet oligosaccharides, isomaltooligosaccharides, xylooligosaccharides, xylo-terminated oligosaccharides, gentiooligosaccharides, fructooligosaccharides, maltooligosaccharides, soybean oligosaccharides and others. Non-limiting examples of carbohydrates include, without limitation, trehalose, galactose, rhamnose, sucrose, glucose, ribulose, fructose, threose, arabinose, xylose, lyxose, allose, altrose, mannose, idose, lactose, maltose, isotrehalose, neotrehalose, isomaltulose, erythrose, deoxyribose, gulose, idose, talose, erythrulose, xylulose, psicose, turanose, amylopectin, glucosamine, mannosamine, fucose, glucuronic acid, abequose, galactosamine, isomaltose, isomaltotriose, panose xylotriose, xylobiose, sorbose, maltotetraol, maltotriol, starch, inulin, raffinose, ribose, and others.

In some embodiments, the carbohydrate is selected amongst reducing sugars. As known in the art, a reducing sugar is a carbohydrate that is oxidized by a weak oxidizing agent under basic aqueous conditions to generate one or more compounds containing an aldehyde group. In some compositions of products of the invention, the carbohydrate, selected as a reducing agent, may be selected amongst monosaccharides and disaccharides. In some embodiments, the reducing sugar may also be selected amongst oligosaccharides and polysaccharides.

In some embodiments, the reducing sugar is selected amongst monosaccharides. Examples include glucose (dextrose), fructose (levulose), galactose, xylose and ribose.

In some embodiments, the reducing sugar is a disaccharide selected from sucrose, lactose, and maltose.

Reducing sugars react with amino acids in the Maillard reaction, a series of reactions that occurs while cooking food at high temperatures, and which determine the flavor of the food product. The Maillard reaction, referred to as a non-enzymatic browning, is a complex process which involves a reaction between a reducing sugar and proteins impacted by heat. The Maillard reaction starts with a reaction of a reducing sugar with an amine, creating glycosylamine, which subsequently undergo a reaction to produce a derivative of amino deoxy fructose. The reaction is continuous and very reactive intermediate substances are formed which subsequently react in several different ways. Eventually, a furan derivate is generated which reacts with other components to polymerize into a dark-colored insoluble material containing nitrogen. Sulphur-containing amino acids play a primary role in the formation of a flavor-intensive components generated during the Maillard reaction.

In some embodiments, the carbohydrate is a non-reducing sugar. As known in the art, non-reducing sugars do not have free ketone or aldehyde group. They are typically characterized as having an acetal in place of hemiacetal group. The non-reducing sugars do not participate in the Maillard reaction. Non-limiting examples of such non-reducing sugars include sucrose, trehalose, raffinose, stachyose and verbascose.

3. Textured Proteins: Textured protein are processed from an edible protein source with or without suitable ingredients that may be added for nutritional or technological purposes. The textured protein may be provided in a form of fibers, shreds, chunks, bits, granules, slices, gels or other forms. To prepare products for consumption, the textured fibrous protein may be hydrated and the fibers are extracted. In some embodiments, the textured protein is made by extrusion, resulting in a modified protein structure of a fibrous, spongy matrix material. In some embodiments, the textured protein may be dehydrated or non-dehydrated.

Irrespective of the method of texturization, a textured protein is an extract material which may be derived from a variety of non-animal source, including plants and fungi. The material may be derived from plants such as legumes and cereals, including beans, rice, maize, barley, sorghum, millet, oats, rye, triticale, breadnut, buckwheat, chia, cockscomb, quinoa, a variety of oilseeds and others. The textured protein may be a textured vegetable protein (TVP). The TVP may be a textured soy protein (TSP), soy meat, or soya chunks.

In some embodiments, the textured protein a textured soy protein.

4. Non-textured protein: The non-textured protein may be any egg protein, plant protein or cell cultured protein. The non-textured protein may be a vegetable-protein, such as soybean protein, a protist-proteins such as yeast and other microbial agents, or animal protein, such as casein. In some embodiments, the non-textured protein is cell cultured animal cells.

5. Fat and fat substitute: Fat substitutes may be in a form of a vegetable oil or an oil material from non-animal sources. The oil may be presented in a combination with water and/or a hydrocolloid material to form a solid or a semi-solid or a gel extrudable material. the oil may be a plant oil selected, for example, from sunflower oil, rapeseed oil, groundnut oil, soybean oil, linseed oil, sesame oil, corn oil, oil, marrow oil, avocado oil, olive oil, walnut oil, hazelnut, almond oil, nut oil and others, as well as mixtures of oils.

The oil may alternatively or additionally be provided in a form of an oleogel.

Oil-water emulsions may be provided with a hydrocolloid materials such as gum arabic, locust bean gum, xanthan gum, pectin, guar gum, carrageenan, iota carrageenan, kappa a salt of alginate, gellan gum, agar, glucomannan, and others.

6. Additives: The additives used in products of the invention may be any coloring agent, an olfactory agent, a stabilizing agent, an antioxidant, and others. In some embodiments, the additive may be selected from glucose, fructose, ribose, arabinose, glucose-6 phosphate, fructose 6-phosphate, fructose 1,6-diphosphate, inositol, maltose, sucrose, maltodextrin, glycogen, nucleotide-bound sugars, molasses, a phospholipid, a lecithin, inosine, pyrazine, lactic acid, succinic acid, glycolic acid, thiamine, creatine, pyrophosphate, vegetable oil, algal oil, corn oil, soybean oil, palm fruit oil, palm kernel oil, safflower oil, flaxseed oil, rice bran oil, cottonseed oil, olive oil, sunflower oil, canola oil, flaxseed oil, coconut oil, mango oil, a free fatty acid, cysteine, methionine, isoleucine, leucine, lysine, phenylalanine, threonine, tryptophan, valine, arginine, histidine, alanine, asparagine, aspartate, glutamate, glutamine, glycine, proline, serine, tyrosine, glutathione, a protein hydrolysate, a malt extract, a yeast extract, and others.

In some embodiments, the at least one additive is a flavoring agent or a material which upon heating or cooking or grilling the cut meat or cut fish product, a meat-like or a fish-like flavor is imparted to the food product.

In some embodiments, the additive is an olfactory agent selected to contribute to the product's aroma.

7. Animal-based components: In some configurations of the technology disclosed herein, animal-based components may be used. Such components may include cells, tissues, bone fragments, muscle fragments, nanofat and other fat components, and others.

In some embodiments, the animal-based components may be used as is or may be provides in mixed combinations with other components.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 depicts a general scheme of a system according to some embodiments of the invention.

FIG. 2 depicts an enlarged view of a part of a system of the invention showing an internal structure of the housing, the feeding tubes, conduits and exit die, utilized according to some embodiments of the invention.

FIGS. 3A-C depict front views of exit ends of systems according to the invention. FIG. 3A shows a front view of a system exit end, wherein the left side depiction contains no flow-disrupting elements, the right side depiction comprises a plurality of flow-disrupting elements for controlling flow of the materials. The bottom part shows cross sections of an extruded product showing simulation of the output flow rates of one material from each of the two devices shown in the top panel of the figure. The darker the color, the higher the flow rate. The position of the intruders 550 are marked with an arrow in each of FIGS. 3B and C.

FIG. 4 depicts a multiplying unit comprising a single multiplying feed block and multiplying die.

FIG. 5 provided a schematic depiction of the multiplication process according to some embodiments of the invention.

FIGS. 6A-B show a substitute cut meat product formed according to some embodiments of the invention (FIG. 6A shows a top view) and a zoom-in (FIG. 6B) showing fine details achieved mimicking whole meat cuts.

FIG. 7 shows an extruded prime prior to slicing as emerging from a system of the invention.

### DETAILED DESCRIPTION OF EMBODIMENTS

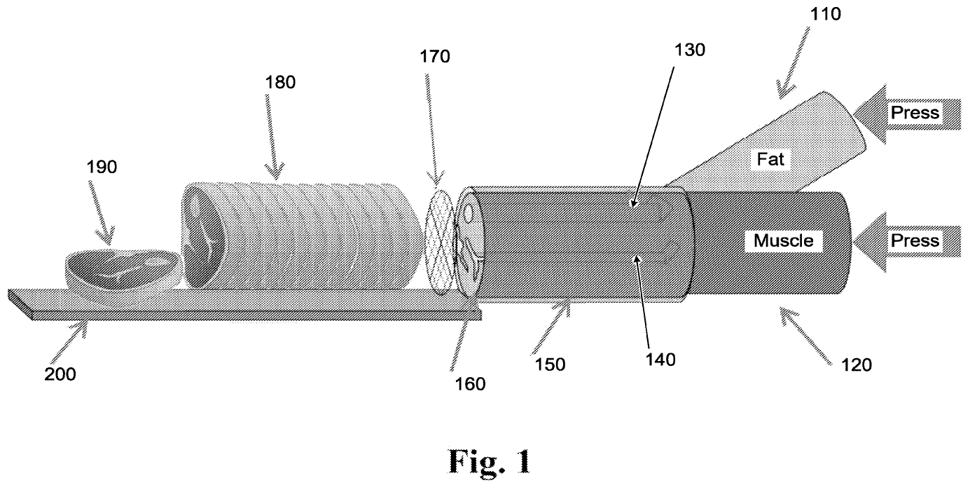

As generally depicted in FIG. 1 below, a system 100 according to some embodiments of the invention comprises

(1) a plurality of material reservoirs comprising each same or different food component, a corresponding plurality of pumps (not shown) and feeding tubes 110 and 120 connecting the reservoirs to the pumps;

(2) a plurality of feeding tubes 110 and 120 for individually interconnecting the pumps with a corresponding plurality of conduits 130 and 140 present in the housing 150 interior. Each of the conduits is associated with a different feeding tube (as demonstrated in the figure, feeding tube 110 delivers a food component, e.g., fat, into conduit 130 and feeding tube 120 delivers another food component, e.g., muscle tissue, into conduit 140). The plurality of conduits 130 and 140 are shaped, sized and aligned in a way to ensure material flow rate to be substantially identical in each conduit. They are positioned at predetermined locations and distances within the housing 150 and shaped to provide a cross section of a desired visuality, mimicking a real cut meat.

The housing has an open front or an exit end 160 and a back end through which the feeding tubes 110 and 120 enter, and the plurality of conduits 130 and 140 extending within the housing interior along their lengths from the pumps (or material reservoirs) to the open front end 160 of the housing.

As shown in FIG. 1, a mesh 170 may be placed at the opening end of the system to texturize the extrudate. The extrudate leaving the housing is in a form of an extruded prime 180 having a cross section mimicking that of a cut meat. As the extruded prime moves out from the extrusion system, it may cut into different portions, e.g., 190, and carried out on a belt 200.

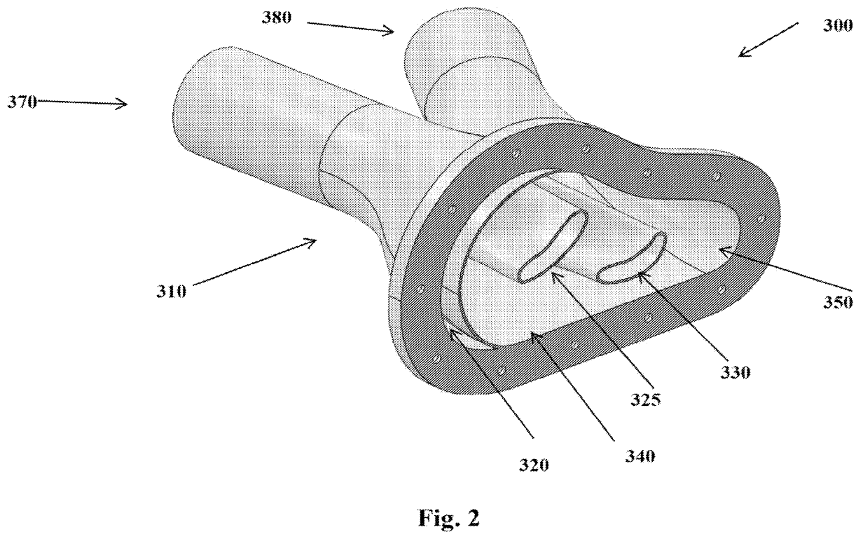

An enlarged view of a die unit utilized according to the invention is provided in FIG. 2. The exemplified unit 300 comprises a housing 310, an internal shape 340. The predefined internal pattern(s) are determined by the cross section of the internal conduits 320. 325 and 330, each delivering a separate and different material compositions or components.

The housing 310 is defined by internal walls 340 shaped and sized to endow the food product with its outer contour, shape and size. The housing has an exit end 350 and a back end defining a material flow from its back opening to its front. The material(s) internally flow through a plurality (three in this case) of conduits 320, 325 and 330, each connected at the housing back end to respective feeding tubes 370, 380 and a third one not shown, and extending therefrom to the front opening of the conduit (and hence to a front opening of the housing).

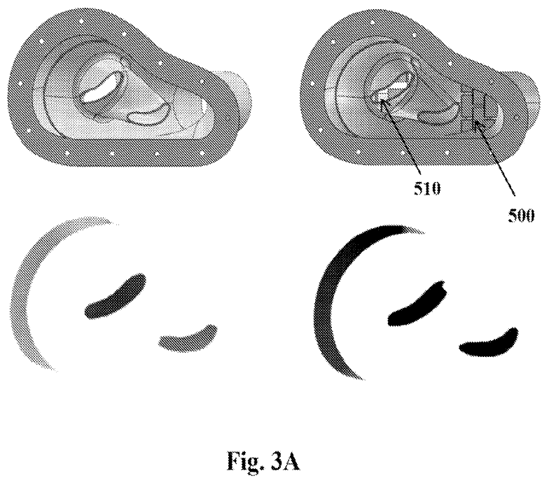

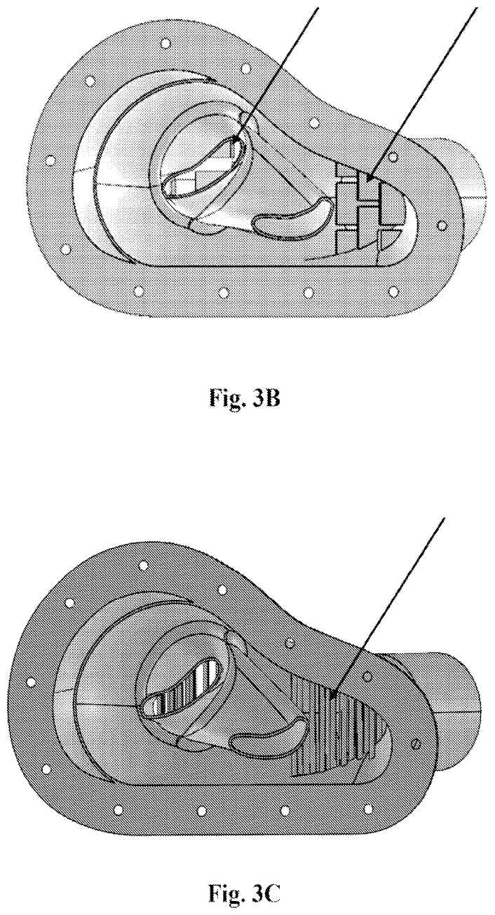

FIG. 3A depicts the unit 300 of FIG. 2, wherein the left side depiction contains no flow-disrupting units, while the right-side depiction comprises a plurality of disrupting units 500 and 510 for controlling flow of the materials. The bottom part of FIG. 3A shows simulation of the output flow rates of one material from each of the two units shown in the top panel of the figure. The darker the color, the higher the flow rate. It is clear that a non-uniform flow is obtained when the flow-disrupting units are absent (left side). Different flow-disrupting units are shown in FIGS. 3B and C, each being marked with an arrow.

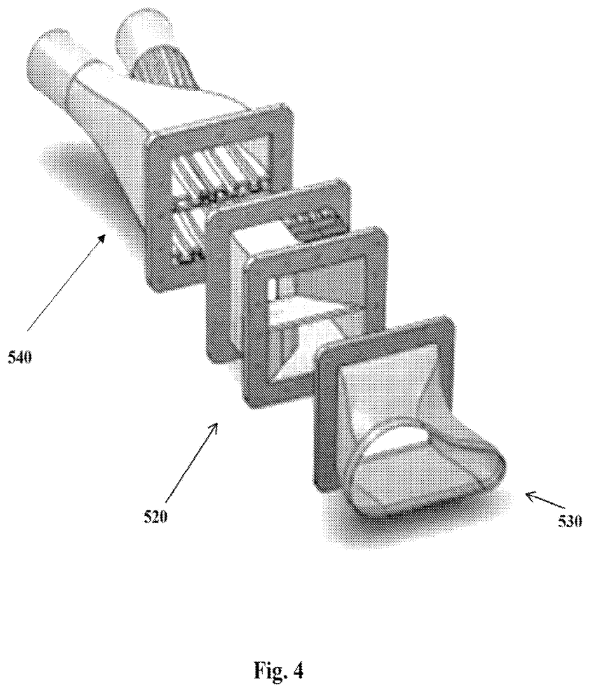

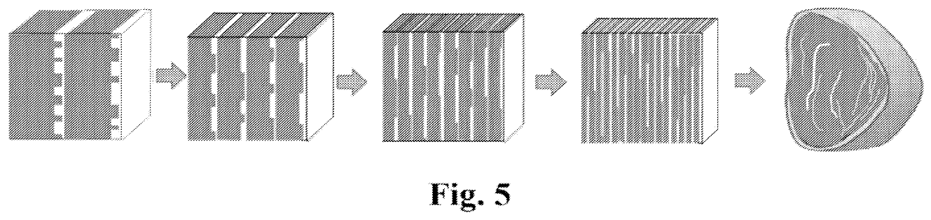

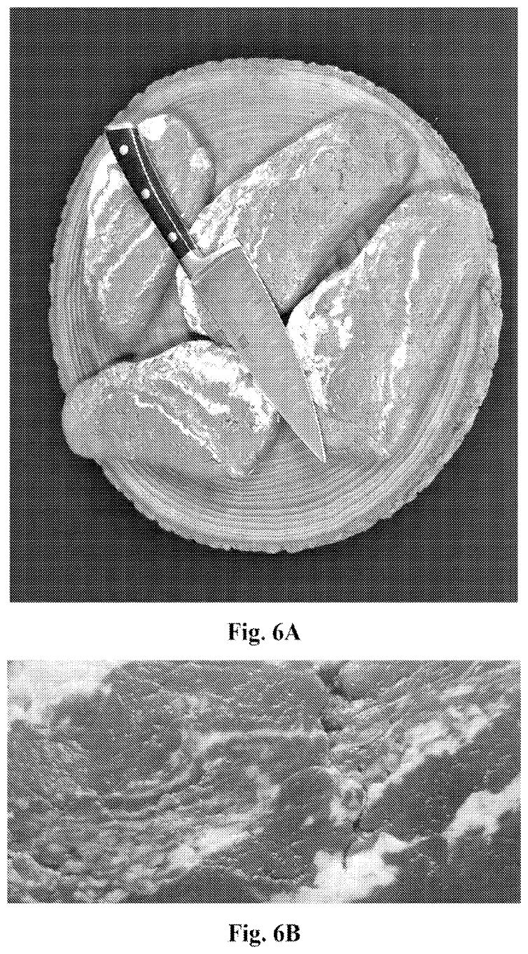

A multiplying unit comprising a single multiplying feed block 540 and a multiplying die 520 is depicted in FIG. 4. As may be noted, the multiplying block and die are positioned, in this specific example, between the material reservoirs positioned at the back of the device and the exit die 530. This particular configuration does not utilize flow-disrupting elements positioned along the path of the material flow. A schematic depiction of a resulting multiplication is further depicted in FIG. 5. Typical products are shown in FIGS. 6A-B including a zoom-in showing the fine details achieved mimicking whole meat cuts.

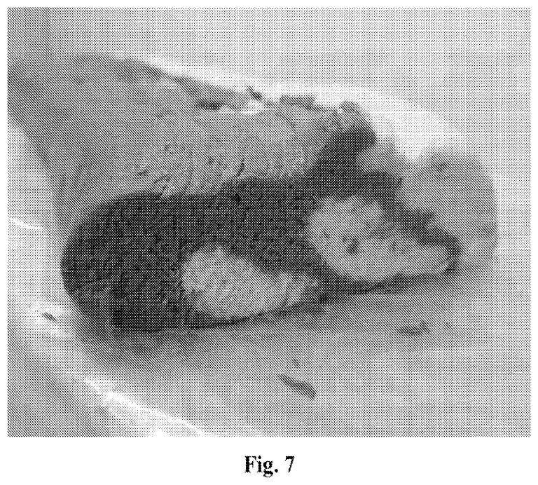

An extruder prime produced at a rate of between 10 and 30 kg/min is shown in FIG. 7. As shown, the various material regions, layers, features or generally structures of one material (colored white) are embedded or mixed in the other material, mimicking the various components of a cut meat.

Various systems of the invention have been used to produce cut meat products, as defined herein. The following are exemplary compositions and processing conditions used on systems of the invention:

### EXAMPLE 1

Fat-like composition (wt %): 48.5% white flour, 2.7% canola oil, 16.1% salt, 33.4% water.

Muscle-like composition (wt %): 48.1 white flour, 2.7% canola oil, 16% salt, 32.9% water, 0.2% coloring agent.

Processing temperature: 25° C.

Each of the compositions was mixed and added into a separate reservoir. The system was operated and materials were allowed to flow through a die system similar to that shown in FIG. 2. The processing temperature was 25° C., each pump piston was operated at a different speed:

Speed of piston (Fat-like composition): 12 (arbitrary units)

Speed of piston (Muscle-like composition): 35 (arbitrary units)

The Production rate was 2.5 kg/min and higher.

### EXAMPLE 2

Fat-like composition (wt %): 90.1% plant-based meat substitute, 0.8% titanium dioxide, 9% margarine.

Muscle-like composition (wt %): 90% plant-based meat substitute, 0.9% beet, 9% gluten.

Each of the compositions was mixed and added into a separate reservoir. The system was operated and materials were allowed to flow through a series of multipliers in a system similar to that shown in FIG. 4. The processing temperature was 25° C., each pump piston was operated at a different speed:

Speed of piston (Fat-like composition): 12 (arbitrary units)

Speed of piston (Muscle-like composition): 35 (arbitrary units) The Production rate was 16 kg/min and higher.

### EXAMPLE 3

Fat-like composition (wt %): 23.1% peas protein, 57.1% water, 11.4% canola oil, 0.9% salt, 0.3% xanthan gum, 1.6% alginate, 2.5% white flour, 2.9% gluten.

Muscle-like composition (wt %): 22.6% peas protein, 55.9% water, 11.2% canola oil, 0.9% salt, 1.9% coloring agent 1, 0.3% coloring agent 2, 0.3% xanthan gum, 1.3% alginate, 2.5% white flour, 2.9% gluten.

Each of the compositions was mixed and added into a separate reservoir. The system was operated and materials were allowed to flow through a series of multipliers in a system similar to that shown in FIG. 4. The processing temperature was 25° C., each pump piston was operated at a different speed:

Speed of piston (Fat-like composition): 12 (arbitrary units)

Speed of piston (Muscle-like composition): 35 (arbitrary units)

The Production rate was 10 kg/min and higher.

1-27. (canceled)

28. A system for extruding a food product, the system comprising a multiplying unit comprising a co-extrusion system, said co-extrusion system comprising:
an extruder provided with one or more pumps,
a co-extrusion feed-block provided between the extruder and a plurality of multiplying die elements arranged in series and
a die unit comprising a housing having an inner cavity and an exit die, the housing having a back end and two or more feeding tubes hermetically positioned at the back end of the housing and extending outwardly therefrom, each of the two or more feeding tubes being independently associated with one of the pumps and with one of two or more material conduits extending inwardly and defining each a path of a material flow from the two or more feeding tubes through the multiplying die elements in a direction of the exit die, wherein the exit die having an inner shape defining a shape of the food product.

29. The system according to claim 28, the system comprising
one or more extruders, each extruder being independently capable of receiving a food component and independently extrude said material;
one or more pumps, each being associated with one extruded food component;
a co-extrusion feed block for receiving the material, wherein the feed block is associated or connected to one or more of a plurality of multiplying die elements, wherein each independently is configured and operable to split or divide said material into a plurality of layers or segments; and
an exit die for forming a structured food product having a cross section showing two or more regions of two or more food components.

30. The system according to claim 28, the system comprising
the one or more material conduits, each defining a stream of a different food component,
a co-extrusion feed block configured to divide one or more of said streams into a plurality of sub-streams and to combine the sub-streams into a first stream of a food composition comprising two or more layers or features of two or more different food components,
a multiplying element configured to mechanically manipulate the first stream and rearrange the layers or features therein to provide a further stream of the food composition, wherein the number of layers or features in the further stream of the two or more different food components is greater than the number of layers or features in the first stream, and
optionally one or more further multiplying elements configured to mechanically manipulate the further stream and rearrange the layers or features therein.

31. A system for producing a food product, the system comprising
a plurality of conduits each defining a stream of a different food component,
a co-extrusion feed block configured to divide one or more of said streams into a plurality of sub-streams and to combine the sub-streams into a first stream of a food composition comprising two or more layers or features of two or more different food components,
a multiplying element configured to mechanically manipulate the first stream and rearrange the layers or features therein to provide a further stream of the food composition, wherein the number of layers or features in the further stream of the two or more different food components is greater than the number of layers or features in the first stream, and
optionally one or more further multiplying elements configured to mechanically manipulate the further stream and rearrange the layers or features therein.

32. The system according to claim 31, wherein the two or more layers or features are arranged in any orientation to each other.

33. The system according to claim 31, comprising a co-extrusion assembly configured to simultaneously extrude two or more different food components.

34. The system according to claim 31, the system comprising a co-extrusion assembly, a multiplying unit and an exit die, wherein the multiplying unit is positioned between the co-extrusion assembly and the exit die in a path of two or more different material streams, each stream being of a different extruded material, said multiplying unit is configured to transform said different extruded materials stream into multiple sub-streams and rearrange said sub-streams to provide a stream of a structured material and flow said stream of a structures material through the exit die defining an external contour of the food product, wherein the co-extrusion assembly comprising one or more material conduits, each being associated with a corresponding material reservoir.

35. The system according to claim 31, the system comprising a die unit comprising a housing having an exit end and a back end and two or more feeding tubes hermetically positioned at the back end of the housing and extending outwardly therefrom, each of the two or more feeding tubes being independently associated with one of two or more material conduits extending inwardly and defining each a path of a material flow from the two or more feeding tubes through the multiplying unit in a direction of the exit end.

36. A process for a continuous production of a shaped food product composed of two or more material regions, the process comprising:
providing a first stream of a food composition comprising at least two layers or features of at least two different food components,
passing the first stream through a multiplying element configured to mechanically manipulate the first stream and rearrange the layers or features therein to provide a further stream of the food composition, wherein the number of layers or features in the further stream is greater than the number of layers or features in the first stream;
optionally passing the further stream through one or more further multiplying elements, and
passing the further stream through an exit die to thereby obtain the shaped food product having two or more material regions.

37. The process according to claim 36, the process comprising
providing a plurality of streams of different food components,
dividing at least two of the plurality of streams into a plurality of sub-streams, and
combining the sub-streams into the first stream of a food composition comprising at least two layers or features of two or more different food components.

38. A process for a continuous production of a shaped food product composed of two or more material regions, the process comprising:
providing a plurality of streams of different food components,
dividing at least two of the plurality of streams into a plurality of sub-streams,
combining the sub-streams into a first stream of a food composition comprising at least two layers or features of two or more different food components,
passing the first stream through a multiplying element configured to mechanically manipulate the first stream and rearrange the layers or features therein to provide a further stream of the food composition, wherein the number of layers or features in the further stream is greater than the number of layers or features in the first stream,
optionally passing the further stream through one or more further multiplying elements, and
passing the further stream through a die to thereby obtain the shaped food product having two or more material regions.

39. The process according to claim 36, the process further comprising passing the first stream through a shaping extrusion die unit before passing same through the multiplying unit such that the input for the multiplying unit is a non-uniform structure.

40. The process according to claim 39, wherein the non-uniform structure is an arbitrarily shaped combination of materials, a layered structure comprising layers of different thicknesses or shapes, a layered structure that is not horizontally aligned with respect to a main axis of the layer-multiplying element, a layered structure having an arbitrarily shaped combination of materials in-between layers, and/or a combination thereof.

41. The process according to claim 36, the process comprising passing the further stream through an exit die after the multiplying unit to allow expansion or reduction of cross section to adjust for a cross section of the food product.

42. The process according to claim 41, wherein the expansion or reduction being optionally formed non-homogeneously to provide twisting, bending and/or stretching of the food product.

43. The process according to claim 36, the process further comprising passing the further stream through an exit die after the multiplying unit, wherein the exit die being part of a housing comprising one or more of a static mixer, an active mixer or a flow-disrupting element.

44. The process according to claim 36, comprising cutting the food product to provide a cut product.

45. The process according to claim 36, wherein the food product is a shaped cut meat or cut fish product.

46. The process according to claim 36, operable at a production rate of between 2.5 and 30 kg/min.
